(19) United States
(12) Patent Application Publication
(10) Pub. No.: US 2017/0056269 A1
(43) Pub. Date: Mar. 2, 2017

(54) PATIENT CARE ROOM WITH REDUCTION OF SPREAD OF PATHOGENS

(71) Applicant: Innovative Designs for Healthcare, LLC, Cheyenne, WY (US)

(72) Inventors: David L. Hadley, Mesa, AZ (US); Hani A. M. Alhourani, Jeddah (SA)

(21) Appl. No.: 15/249,823

(22) Filed: Aug. 29, 2016

Related U.S. Application Data
(60) Provisional application No. 62/212,766, filed on Sep. 1, 2015.

(51) Int. Cl. A61G 10/00; A47K 17/00; E03D 9/00; E03D 9/04; A47K 1/00; A61G 9/00

(52) U.S. Cl. CPC A61G 10/00; A47K 1/00; A61G 9/003; E03D 9/002; E03D 9/04; A47K 17/00

(57) ABSTRACT

A patient care room and method of treating a patient in a patient care room includes a patient treatment area that is configured to accept a patient support, such as a bed, and a waste containment room that is walled from said treatment area. The waste containment room has a toilet and a door that selectively separates the waste containment area from the treatment area and a decontaminating unit. The decontaminating unit is capable of killing common pathogens. An airflow system discharges air from the waste containment room to outside of the patient care room thereby creating a negative pressure in the waste containment room with respect to the treatment area.

### CROSS REFERENCE TO RELATED APPLICATIONS

This application claims priority from U.S. patent application Ser. No. 62/212,766, filed on Sep. 1, 2015, the disclosure of which is hereby incorporated herein by reference.

### BACKGROUND OF THE INVENTION

The present invention is directed to a methodology for reducing the spread of infectious disease including airborne pathogens. While the invention is illustrated for use in an intensive care unit of a hospital, it may find use in other hospital settings and in non-hospital patient care facilities.

Recent research has uncovered the fact that airborne bacteria and viruses can remain in a patient's room and survive in the air for several months, and that these airborne contaminants are the result of current everyday nursing practices throughout the world. In an effort to reduce the transmission of infection by contact; hand-washing sinks, and either toilets or clinical sinks, have been recommended and installed in the patient's room. One result of this has been the spread of airborne antibiotic resistant bacteria, which has resulted in the death of many patients.

### SUMMARY OF THE INVENTION

The present invention recognizes that the sink drains and the aerosol resulting from the hand-washing process and water flow into the drains is a source of infectious airborne bacteria due to the normal airflow that exists in the room. In nearly all patient rooms, the air return registers are located in the ceiling, drawing any airborne bacteria or virus upwards either onto the staff or into the air which is recirculated. Therefore, when the nurse is washing his or her hands after cleaning a patient that may have an infection, the aerosol created in the process of water splashing on the hands gets into the airflow rising upwards and spreads into the air and onto the nurse. Plus, the water flow into the drain creates an aerosol that gets into the airstream.

In order to reduce the amount of bacteria laden aerosol going back onto the nurse and into the air of the room, a waste containment room design and method is provided which decontaminates air and exhausts the decontaminated air from the building. A sink design and method exhausts the air surrounding the sink into the waste containment room where it is decontaminated and exhausted.

A patient care room and method of treating a patient in a patient care room, according to an aspect of the invention, includes a patient treatment area that is configured to accept a patient support, such as a bed, a waste containment room that is walled from said treatment area. The waste containment room has a toilet and a door that selectively separates the waste containment area from the treatment area and a decontaminating unit. The decontaminating unit is capable of killing common pathogens. An airflow system discharges air from the waste containment room to outside of the patient care room thereby creating a negative pressure in the waste containment room with respect to the treatment area.

A hand-washing fixture is configured to wash hands of a treatment practitioner. The hand-washing fixture may be outside of the waste containment room and includes an exhaust exhausting air from the hand-washing fixture to the waste containment room. The exhaust may be at height of the hand-washing fixture. The decontaminating unit may include an ultraviolet lamp. The ultraviolet lamp may shine on the toilet. A sensor may be provided for sensing a person in the waste containment room and de-energizing the ultraviolet lamp when a person is in the waste containment room. The sensor may energize a visible lamp when a person is in the waste containment room. The airflow system may receive air from said waste containment room from an air return at floor level. The airflow system may discharge air from the waste containment room to outside of a building housing the patient care room.

A soiled material collection bin may be provided. The collection bin is accessible at the patient room for depositing soiled material and accessible outside of the patient care room for collecting soiled material. In this manner, soiled material can be deposited without exiting the patient care room and collected without entering the patient care room. The soiled material collection bin may be accessible to the waste containment room for depositing soiled material. The soiled material collection bin may be vented to outside of a building housing the patient care room.

A decentralized supply store may be provided in the patient treatment area for storing supplies needed to treat a patient. In this manner, treatment personnel do not need to leave the patient treatment area to obtain supplies. The supply store may include a supply sensor for determining a need to restock the supply store. The supply sensor may detect types of items. In this manner, the determining of a need to restock the supply store may be determined according to individual types of items. The supply store may be adjacent the room entry door. In this manner, a supply clerk can restock the supply store without entering the patient treatment area.

Thus, aspects of the present invention reduce and/or eliminate transmission of pathogens by the use of an exhaust vent in the wall above the sink, the exhaust of the waste containment room at floor level to prevent air flow upwards, the waste transfer bins, which are also exhausted to outside the building, the decentralized supply bins with auto re-order sensors, the waste disposal port through the wall of the room above the sink, and the sensor controlled UVC light in the waste containment room. These aspects reduce airborne infection within healthcare facilities.

These and other objects, advantages and features of this invention will become apparent upon review of the following specification in conjunction with the drawings.

### BRIEF DESCRIPTION OF THE DRAWINGS

FIG. 1 is a perspective view illustrating a patient care room according to an embodiment of the invention;

FIG. 2 is a top plan view of the patient care room in FIG. 1;

FIG. 3 is a perspective view illustrating a waste containment room;

FIG. 4a is an elevation view of a soiled material collection bin as seen inside the waste containment room;

FIG. 4b is a sectional view taken along the lines B-B in FIG. 4a;

FIG. 4c is an elevation view of the soiled material collection bin as seen outside the patient room;

FIG. 4d is an elevation view showing exhaust ports at a side of the soiled material collection bin; and

FIG. 5 is a perspective view of a hallway outside of the patient care room illustrating the soiled material collection bins.

### DESCRIPTION OF THE PREFERRED EMBODIMENT

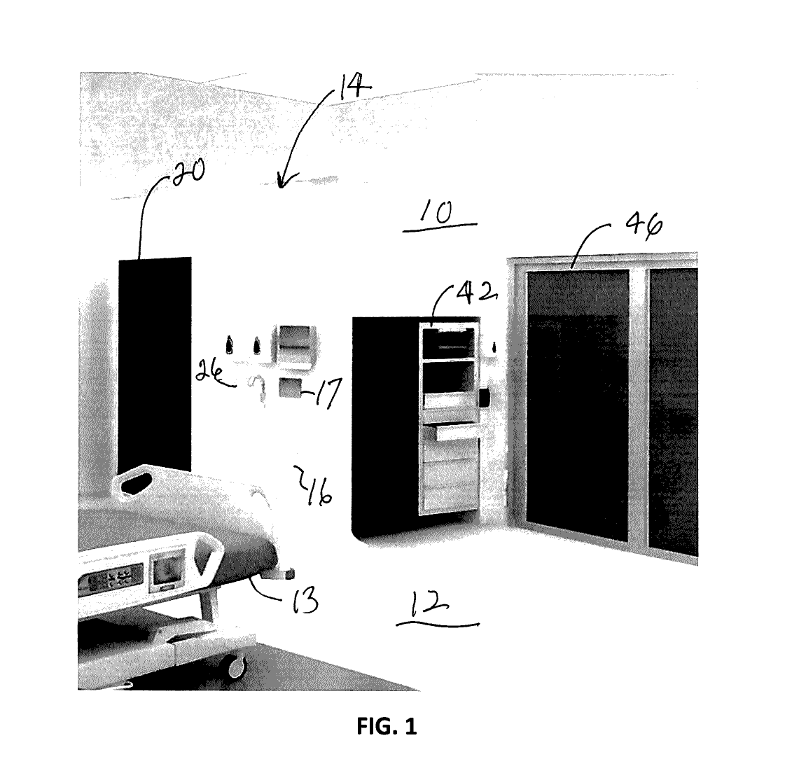

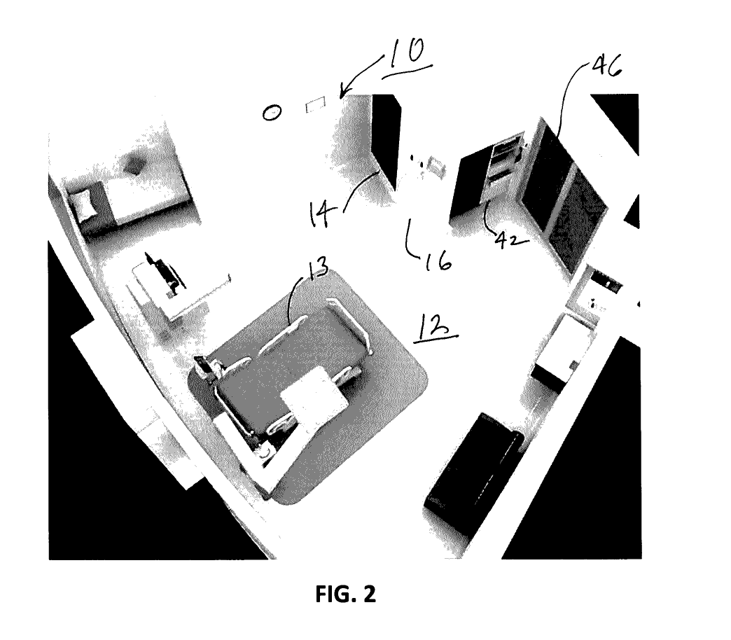

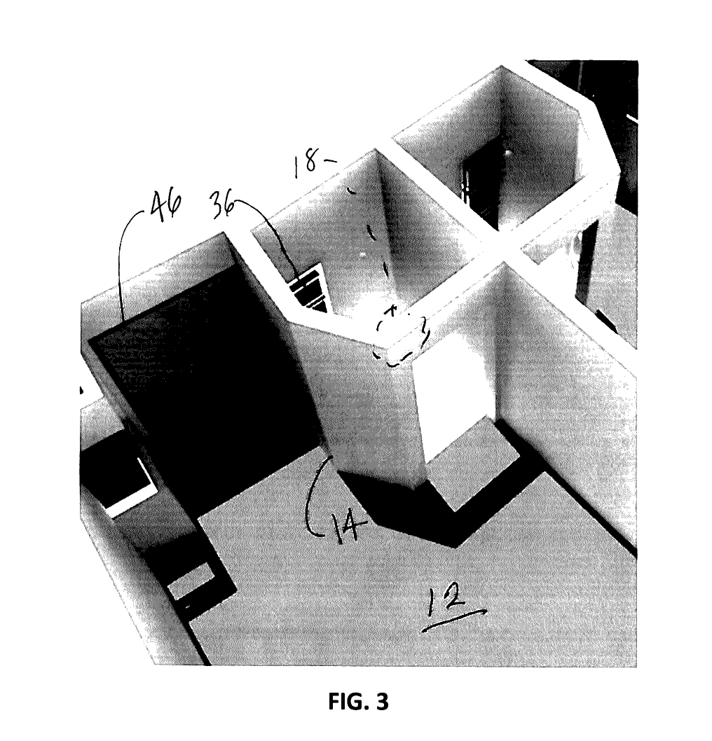

Referring now specifically to the drawings, and the illustrative embodiments depicted therein, a patient care room 10 includes a patient treatment area 12 that is configured to accept a patient support structure, such as a bed 13 (FIGS. 1 and 2). Patient care room 10 includes a waste containment room 14 that is walled from treatment area 12. A hand-washing fixture 16 that is configured to wash hands of a treatment practitioner is mounted in patient treatment area 12, but on a wall dividing the patient treatment area from waste containment room 14. In order to reduce the amount of bacteria laden aerosol going back onto the nurse or other practitioner and into the air of the patient treatment area, the air surrounding washing fixture 16 is exhausted into the waste containment room 14 where it is decontaminated and exhausted from the building.

Waste containment room 14 has a toilet 18 and a door 20 that selectively separates waste containment room 14 from patient treatment area 12 and a decontaminating unit 22 which is capable of disinfecting common pathogens. An airflow system 24 discharges air from waste containment room 14 to outside of the patient care room thereby creating a negative pressure in said waste containment room with respect to the treatment area. The negative pressure will cause any air exchange between the patient treatment area 12 and the waste containment room 14 to flow to the waste containment room not vice versa.

Hand-washing fixture 16 is in the patient treatment area 12 where it is readily accessible but outside of the waste containment room 14. An exhaust 26 exhausts air from hand-washing fixture 16 to waste containment room 14. Exhaust 26 is at height of the hand-washing fixture 16 and immediately adjacent the hand-washing fixture so that any aerosol from the sink drains and the aerosol resulting from the hand-washing process and water flow into the drains will be exhausted away from the practitioner and into the waste treatment room. A waste receptacle 17 may be positioned adjacent exhaust 26. Waste receptacle 17 may terminate in waste containment room 14 so that waste, which may be contaminated, is transferred to the waste containment room without the need to open door 20.

Decontaminating unit 22 may be an ultraviolet (UVC) lamp 30. Ultraviolet lamp 30 is mounted to the ceiling or upper wall of the waste containment room 14 such that is shines on the toilet in order to treat any aerosol resulting from the dumping of a bed pan or flushing of the toilet. A sensor 28, which may be a proximity sensor, thermal sensor or that like, senses a person in the waste containment room and de-energizes ultraviolet lamp 30 when a person is in the waste containment room. In addition, sensor 28 energizes a visible lamp 32 when a person is in the waste containment room to provide the ability to see in the room. The UVC light will automatically turn off after being on long enough to disinfect the room.

Waste containment room 14 includes an airflow system having an air return vent 34 that receives air from the waste containment room from an air return at floor level. The airflow system discharges air from the waste containment room to outside of the building housing patient care room 10. By placing the exhaust return for the waste containment room below the level of the top of the toilet rim or clinical sink, any aerosol resulting from dumping of a bed pan or flushing of the toilet will be drawn down to the wall exhaust rather than flowing upwards into the airstream, or onto the nurse or room occupant.

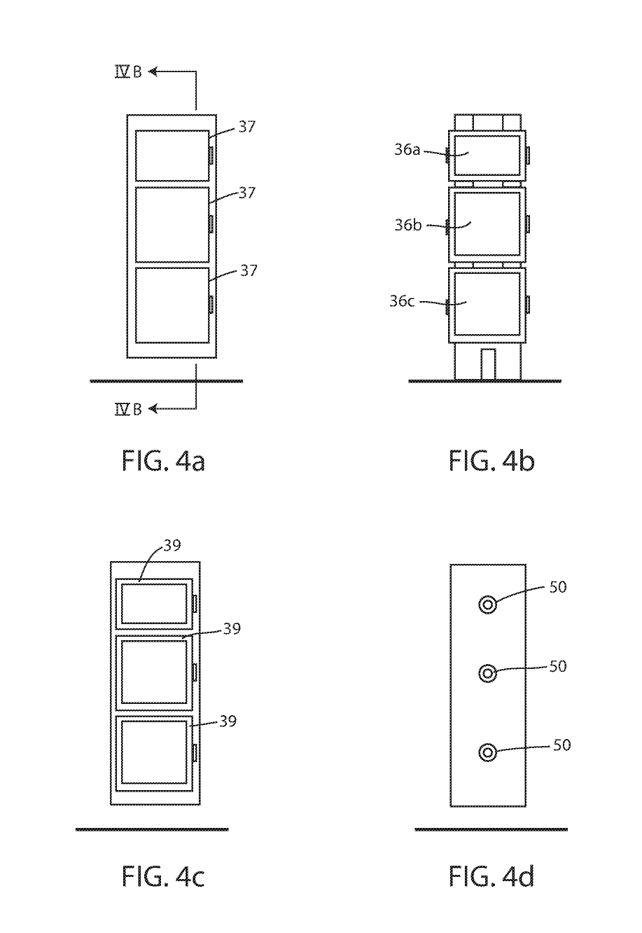

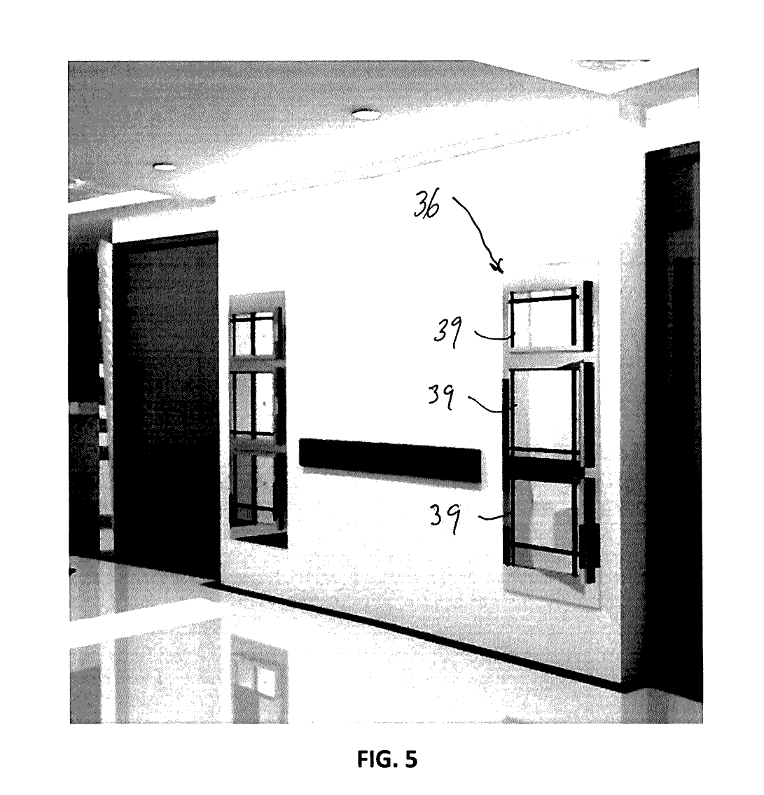

Patient care room 10 includes a soiled material collection bin 36 divided into hatches 36a, 36b, 36c. Collection bin 36 is accessible to patient care room 10 within or through waste containment room 14 via doors 37, one for each hatch shown in FIG. 4a, for depositing soiled material from the patient care room via the waste containment room. Collection bin 36 is accessible outside of the patient care room via doors 39, one for each hatch, for collecting soiled materials, as best seen in FIG. 5. Doors 39 are outside of patient care room 10 wherein soiled material can be deposited without exiting the patient care room and collected without entering the patient care room. Contact transfer of contaminants is another means of transmitting and transporting infection from one room to another. Soiled material collection bins 36 reduce the transfer of infectious material which may be on soiled linens, patient gowns, diapers, or soiled bandages or pads, whether it be bacteria, fungus, or virus. Bins 36 reduce the traffic of non-clinical personnel, such as housekeeping, within the patient zones. Each waste transfer hatch is also vented via ports 50 to the outside, as seen in FIG. 4d to prevent the build-up of pressure in the hatch which might be a source of contamination to the hallway when opened.

Thus, it can be seen that all waste is placed in the waste containment room 14 where it is collected from the hallway through transfer hatches 36a, 36b and 36c. Therefore, all contaminated linen, waste, and needles or sharp containers are collected in the hallway from its designated compartment, thus avoiding the need for the housekeeping or laundry staff to go from room to room collecting contaminated materials from inside. Keeping the soiled materials in each room's waste containment area which is under negative pressure and being exhausted to the outside of the building reduces the spread of airborne bacteria within the room, and from room to room.

A decentralized supply store 42 in the patient treatment area 12 stores clean supplies needed to treat a patient. Thus, treatment personnel do not need to leave the patient treatment 12 area to obtain supplies from central supply. Supply store 42 includes a supply sensor 44 that senses supplies in supply store 42 to determine a need to restock the supply store. Supply sensor 44 detects types of items in order to determine a need to restock the supply store according to individual types of items. Decentralized supply store 42 is adjacent the room entry door 46 so that a supply clerk can restock the supply store without entering the patient treatment area. In addition to allowing supplies to be obtained without needing to leave patient treatment area 12, decentralized supply store 42 may also eliminate a need for a central supply store in each patient ward or nursing floor and thereby better utilize space in the medical facility.

In addition to the above, all furniture in patient care room 10 except the patient's bed is off the floor to ease room cleaning and avoid collection areas where dust laden with bacteria, fungus, or virus can collect.

While the foregoing description describes several embodiments of the present invention, it will be understood by those skilled in the art that variations and modifications to these embodiments may be made without departing from the spirit and scope of the invention, as defined in the claims below. The present invention encompasses all combinations of various embodiments or aspects of the invention described herein. It is understood that any and all embodiments of the present invention may be taken in conjunction with any other embodiment to describe additional embodiments of the present invention. Furthermore, any elements of an embodiment may be combined with any and all other elements of any of the embodiments to describe additional embodiments.

The embodiments of the invention in which an exclusive property or privilege is claimed are defined as follows:

1. A patient care room, comprising:
a patient treatment area that is configured to accept a patient support;
a waste containment room that is walled from said treatment area; and
said waste containment room having a toilet and a door that selectively separates said waste containment area from said treatment area and a decontaminating unit, said decontaminating unit capable of killing common pathogens and an airflow system, said airflow system discharging air from said waste containment room to outside of the patient care room thereby creating a negative pressure in said waste containment room with respect to the treatment area.

2. The patient care room as claimed in claim 1 including a hand-washing fixture that is configured to wash hands of a treatment practitioner, wherein said hand-washing fixture is outside of the waste containment room and including an exhaust exhausting air from said hand-washing fixture to said waste containment room.

3. The patient care room as claimed in claim 2 wherein said exhaust is at height of the hand-washing fixture.

4. The patient care room as claimed in claim 1 wherein said decontaminating unit comprises an ultraviolet lamp that shines on the toilet and a sensor sensing a person in the waste containment room and de-energizing said ultraviolet lamp when a person is in the waste containment room.

5. The patient care room as claimed in claim 1 wherein said airflow system receives air from said waste containment room from an air return at floor level.

6. The patient care room as claimed in claim 1 including a soiled material collection bin, said collection bin accessible to said patient care room for depositing soiled material and accessible outside of the patient care room for collecting soiled material, wherein soiled material can be deposited without exiting the patient care room and collected without entering the patient care room.

7. The patient care room as claimed in claim 6 wherein the soiled material collection bin is accessible to the waste containment room for depositing soiled material.

8. The patient care room as claimed in claim 6 wherein said soiled material collection bin is vented to outside of a building housing the patient care room.

9. The patient care room as claimed in claim 1 including a decentralized supply store in the patient treatment area for storing supplies needed to treat a patient whereby treatment personnel do not need to leave the patient treatment area to obtain supplies.

10. The patient care room as claimed in claim 9 wherein said supply store includes a supply sensor, said supply sensor determining a need to restock the supply store.

11. The patient care room as claimed in claim 10 wherein said supply sensor detects types of items wherein said determining a need to restock the supply store is determined according to individual types of items.

12. The patient care room as claimed in claim 9 wherein the room has a main entry door and wherein said supply store is adjacent the room entry door, whereby a supply clerk can restock the supply store without entering the patient treatment area.

13. The patient care room as claimed in claim 1 wherein said patient support comprises a bed.

14. A method of treating a patient in a patient care room, comprising:
treating a patient with a practitioner in a patient treatment area of the care room that is configured to accept a patient support; and
disposing of patient waste in a waste containment room within the care room that is walled from said treatment area without leaving the care room, said waste containment room having a toilet and a door that selectively separates said waste containment area from said treatment area and a decontaminating unit, said decontaminating unit capable of killing common pathogens and an airflow system, said airflow system discharging air from said waste containment room to outside of the patient care room thereby creating a negative pressure in said waste containment room with respect to the treatment area.

15. The method of treating as claimed in claim 14 wherein said disposing of patient waste includes emptying a patient's bed pan in the toilet without leaving the care room.

16. The method of treating as claimed in claim 14 including washing the hands of the practitioner with a hand-washing fixture in the patient care room wherein said hand-washing fixture is outside of the waste containment room and including an exhaust exhausting air from said hand-washing fixture to said waste containment room.
